(19) United States
(12) Patent Application Publication
(10) Pub. No.: US 2007/0188480 A1
(43) Pub. Date: Aug. 16, 2007

(54) DIGITAL PEN

(75) Inventors: Shu-Hsuan Teng, Taipei City (TW); Kuan-Ting Chen, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: COMPAL ELECTRONICS, INC., Taipei City (TW)

(21) Appl. No.: 11/458,094

(22) Filed: Jul. 17, 2006

(30) Foreign Application Priority Data
Feb. 15, 2006 (TW) 95105009

(51) Int. Cl. G06F 3/033

(52) U.S. Cl. 345/179

(57) ABSTRACT

A digital pen including a pen body and a radio frequency module is provided. The pen body has a first end and a second end. The radio frequency module is installed within the pen body and is used to send out a first signal at the first end and a second signal at the second end. A first frequency region of the first signal is not overlapped with a second frequency region of the second signal. The digital pen utilizes the first frequency region and the second frequency region to be correspondingly used for the writing function and the erasing function separately, such that the digital pen is more convenient for being used by a user.

### CROSS-REFERENCE TO RELATED APPLICATION

This application claims the priority benefit of Taiwan application serial no. 95105009, filed on Feb. 15, 2006. All disclosure of the Taiwan application is incorporated herein by reference.

### BACKGROUND OF THE INVENTION

1. Field of Invention

The present invention relates to a digital pen, and more particularly to a digital pen with writing and erasing functions.

2. Description of Related Art

With the development of computer technology, a computer has gradually become a user's recording medium. The computer is generally controlled and used via a mouse and a keyboard, which, however, are inconvenient and limited in nature when being used to input data or make a drawing. Therefore, various input devices and digital panels have gradually appeared, and currently, the most popular digital panel is a personal digital assistant (PDA) or a tablet PC. As for the input device, in order to cater to people's habits, a digital pen has been developed, such that using the digital pen to input data or make drawings is just like using pens and paper before.

FIG. 1 is a schematic view of a conventional digital pen. Referring to FIG. 1, ROC Patent Publication No. M255462 discloses a digital pen 101, which comprises a pen body 110, a radio frequency module 120 and a rotating element 130. The pen body 110 is used to cover the radio frequency module 120. The radio frequency module 120 is composed by coupling to a signal generating circuit and is disposed at one end of the pen body 110. The rotating element 130 is disposed within the pen body 110 and a part of the rotating element 130 is exposed outside the pen body 110. Additionally, the rotating element 130 is electrically connected to the radio frequency module 120 to control the frequency of a signal sent out by the radio frequency module 120.

Since the rotating element 130 is used to control the frequency of a signal sent out by the radio frequency module 120, a user may utilize the rotating element 130 to select the attributes, such as font, color or line thickness of the word he/she will input, when moving a digital pen on a digital panel (not shown) to write data. Taking the font as an example, when the rotating element 130 is rotated to correspond to one of the scales 112 of the pen body 110, meanwhile the radio frequency module 120 sends out a signal corresponding to a specific frequency, thereby changing the font in the writing function correspondingly. These scales 112 make the radio frequency module 120 send out signals with different frequencies. Then, the signals with different frequencies are received by the digital panel (not shown) and then, the frequencies of the signals are determined, thereby changing the font of the writing function into DFKai-SB, MingLiu, PMingLiu or SimHei. Similarly, the rotating element 130 also can be used to control the color of the writing function as red, orange, yellow and green, or control the line thickness of the writing function to be extra fine, fine, medium fine, medium bold, bold, etc.

In the specification of ROC Patent Publication No. M255462, besides the digital pen 101 using the rotating element 130 as an element for selecting attributes of the writing function, a digital pen 102 using retractable elements 140 as the element for selecting attributes is also provided, as shown in FIG. 2. When a user presses down one of the retractable elements 140, the radio frequency module 120 sends out a signal corresponding to the frequency of the retractable element 140, such that the digital pen 102 has the writing function corresponding to different fonts, colors and line thickness.

However, the digital pen using either the rotating element or the retractable element as the attribute-selection element is designed only directing to selecting the type of the writing data. When the user intends to erase the data, he/she must click the button for erasing data on the digital panel via the digital pen, so as to delete the data to be erased, and then click the button corresponding to the writing function on the digital panel, so as to make the digital pen be switched back to the writing function. Such process of erasing data is relatively inconvenient for the user when using the digital pen.

### SUMMARY OF THE INVENTION

Accordingly, one objective of the present invention is to provide a digital pen with the writing and erasing functions.

In order to achieve the aforementioned or other objectives, the present invention provides a digital pen, which comprises a pen body and a radio frequency module. The pen body of the digital pen has a first end and a second end. The radio frequency module is installed within the pen body and is used for sending out a first signal at the first end and a second signal at the second end. A first frequency region of the first signal is not overlapped with a second frequency region of the second signal.

In one embodiment of the present invention, the first end is a pen nib and the second send is a pen tail opposite to the pen nib.

In another embodiment of the present invention, the first signal corresponds to a writing operation of the digital pen and the second signal corresponds to an erasing operation of the digital pen.

In still another embodiment of the present invention, the first frequency region falls within 120K-250K Hertz (Hz) and the second frequency region falls within 40K-80K Hz.

In order to achieve the aforementioned or other objectives, the present further provides a digital pen, which comprises a pen body, a radio frequency module and a push button switch. The radio frequency module is installed within the pen body to send out a signal with the frequency being in a first frequency region. The push button switch is disposed on the pen body and electrically connected to the radio frequency module. Upon being pushed, it adjusts the frequency of the signal sent out by the radio frequency module from the first frequency region to the second frequency region that is not overlapped with the first frequency region.

In one embodiment of the present invention, the push button switch is a one-way switch, wherein when the push button switch is not pushed makes the digital pen correspond to the writing operation, and when the push button switch is being pushed, the signal makes the digital pen correspond to the erasing operation.

In another embodiment of the present invention, the push button switch is a two-way switch, which is switched between a first position and a second position. When the push button switch is at the first position, the signal makes the digital pen correspond to the writing operation, and when the push button switch is at the second position, the signal makes it correspond to the erasing operation.

In still another embodiment of the present invention, the first frequency region falls within 120K-250K Hz and the second frequency region falls within 40K-80K Hz.

Based upon the above, the present invention utilizes the first signal and the second signal sent out by the radio frequency module to make the digital pen correspond to the writing function and the erasing function, such that it is more convenient for the user to write and erase data on the digital panel through the digital pen.

In order to make the aforementioned and other objectives, features and advantages of the present invention comprehensible, preferred embodiment accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a conventional digital pen.

FIG. 2 is a schematic view of another conventional digital pen.

FIG. 3 is a schematic view of a digital pen being applied in a digital panel for writing data according to one embodiment of the present invention.

FIG. 4A is a schematic view of the digital pen in FIG. 3.

FIG. 4B is a side view of the digital pen in FIG. 4A.

FIG. 5A is a schematic view of a digital pen according to another embodiment of the present invention.

FIG. 5B is a side view of the digital pen in FIG. 5A.

FIG. 6 is a schematic view of a digital pen according to still another embodiment of the present invention.

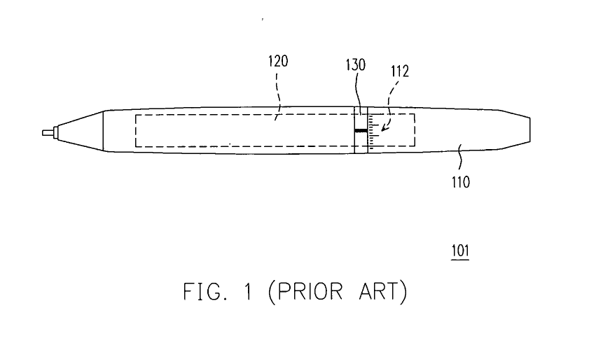

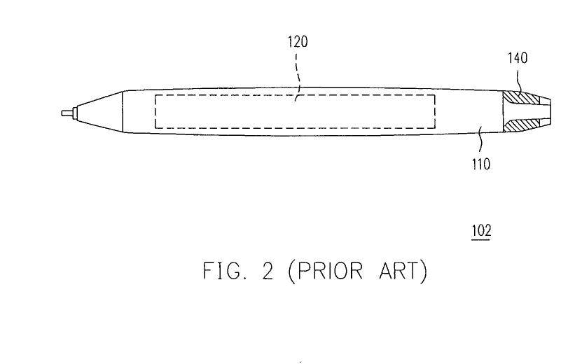

### DESCRIPTION OF EMBODIMENTS

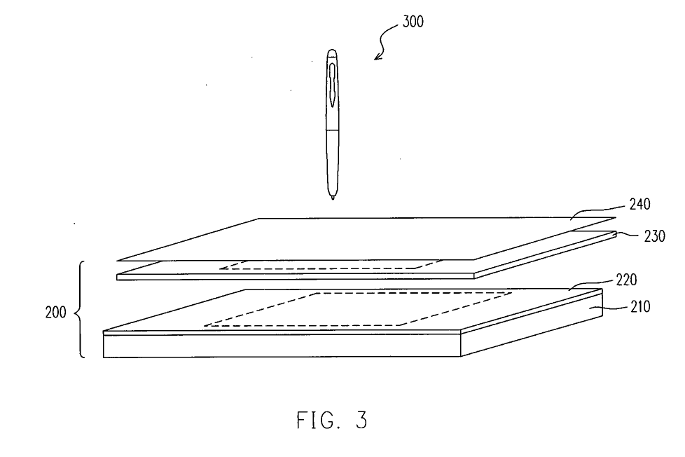

The digital pen in this embodiment being applied in a digital panel for writing data is described below. FIG. 3 is a schematic view of a digital pen being applied with a digital panel for writing data according to one embodiment of the present invention. Referring to FIG. 3, the digital pen 300 in this embodiment is suitable to move on a digital panel 200 for writing data. The digital panel 200 comprises a case 210, a circuit module 220, a liquid crystal display (LCD) 230 and a protecting plate 240. The case 210 is used to cover the circuit module 220, the LCD 230 and the protecting plate 240. The circuit module 220 may be a circuit module 220 containing a combination of a receiving module or a radio frequency module. The LCD 230 is a display for displaying data. The protecting plate 240 protects the LCD 230 from being damaged. The elements of the digital pen 300 will be described in detail below, thus those skilled in the art further understand the present invention.

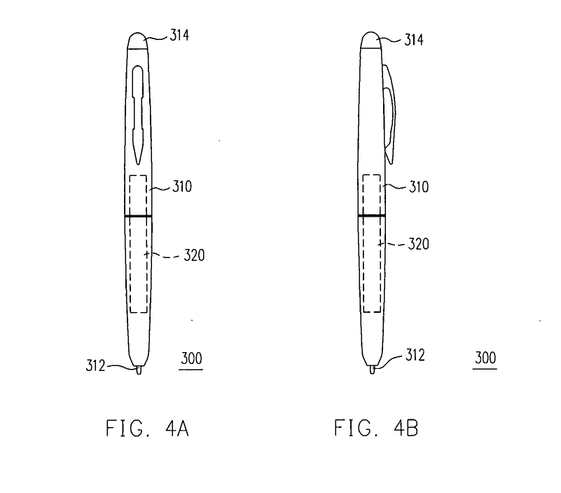

FIG. 4A is a schematic view of the digital pen in FIG. 3, and FIG. 4B is a side view of the digital pen in FIG. 4A. Referring to FIGS. 4A and 4B, the digital pen 300 comprises a pen body 310 and a radio frequency module 320. The pen body 310 has a first end 312 and a second end 314, wherein the first end 312 is a pen nib of the pen body 310 and the second end 314 is a pen tail of the pen body 310 opposite to the pen nib. The radio frequency module 320 is installed within the pen body 310 to send out a first signal at the first end 312 and a second signal at the second end 314, wherein a first frequency region of the first signal is not overlapped with a second frequency region of the second signal.

As for the working principle of the digital pen 300, when the pen nib of the digital pen 300 touches the digital panel 200 (as shown in FIG. 3), and the circuit module 220 of the digital panel 200 receives a first signal sent out by the radio frequency module 320 at the first end 312 (i.e., the pen nib), the digital pen 300 corresponds to a writing function when moving on the digital panel 200. On the contrary, when the circuit module 220 of the digital panel 200 receives a second signal sent out by the radio frequency module 320 at the second end 314 (i.e., the pen tail), the digital pen 300 corresponds to an erasing function when moving on the digital panel 200. In short, the first signal makes the digital pen 300 correspond to the writing operation and the second signal makes the digital pen 300 correspond to the erasing operation, such that the digital pen 300 is used just like a pencil, that is, the pen nib is used to write and the pen tail functions as an eraser. In this embodiment, the first signal is in the first frequency region, for example, 120K-250K Hz, and the second signal is in the second frequency region, for example, 40K-80K Hz.

Provided that the digital pen 300 sends out the first signal and the second signal simultaneously at the first end 312 and the second end 314 through the radio frequency module 320, the circuit module 220 of the digital panel 200 determines whether the first end 312 or the second end 314 of the digital pen 300 moves on the digital panel 200 by comparing the strength of the first signal with that of the second signal. In other words, when the first signal send out at the first end 312 and the second signal sent out at the second end 314 are received by the circuit module 220 on the digital panel 200, the strength of the first signal and that of the second signal are different due to the length of the pen body 310 of the digital pen 300. Therefore, whether the first end 312 or the second end 314 of the digital pen 300 is more close to the digital panel 200 can be determined through this method.

Since the radio frequency module 310 of the digital pen 300 works based upon the electrical power supply, it has a built-in power, such as a battery. For saving power, besides the function of receiving a signal, the circuit module 220 of the digital panel 200 further has the function of sending out a signal. The radio frequency module 320 of the digital pen 300 senses the signal sent out by the circuit module 220 of the digital panel 200 and converts the energy of the signal into the energy for generating the first signal and the second signal, such that a built-in power supply may be omitted in the radio frequency module 310 of the digital pen 300.

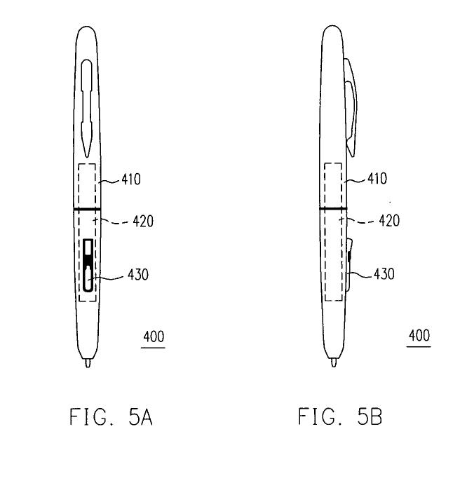

FIG. 5A is a schematic view of a digital pen according to another embodiment of the present invention, and FIG. 5B is a side view of the digital pen in FIG. 5A. Referring to FIGS. 5A and 5B, the digital pen 400 differs from the digital pen 300 in FIG. 4A in that, the digital pen 400 further comprises a push button switch 430. The push button switch 430 is disposed on the pen body 410 and electrically connected to the radio frequency module 420, and upon being pushed, it is used to adjust the frequency of the signal sent out by the radio frequency module 420 from a first frequency region to a second frequency region that is not overlapped with the first frequency region. Particularly, the push button switch 430 is a one-way switch, thus, when a user does not push the push button switch 430, the radio frequency module 420 of the digital pen 400 sends out a first signal in the first frequency region to make the digital pen 400 correspond to a writing operation; on the contrary, when the user has pushed the one way switch 432, the radio frequency module 420 of the digital pen 400 sends out a second signal in the second frequency region to make the digital pen 400 correspond to an erasing operation.

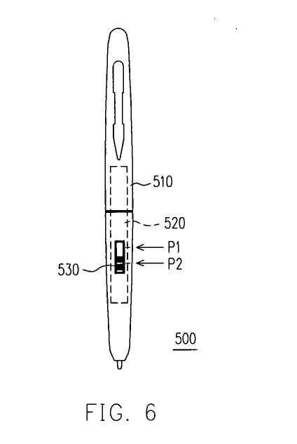

FIG. 6 is a schematic view of a digital pen according to still another embodiment of the present invention. Referring to FIG. 6, the digital pen 500 differs from the digital pen in FIG. 5A in that, the push button switch 530 is a two-way switch, which is switched between a first position P1 and a second position P2. Therefore, when the push button switch 530 is at the first position P1, the radio frequency module 520 of the digital pen 500 sends out a first signal to make the digital pen 500 correspond to a writing operation. Additionally, when the push button switch 530 is at the second position P2, the radio frequency module 520 of the digital pen 500 sends out a second signal to make the digital pen 500 correspond to an erasing operation. In this embodiment, the first signal is in the first frequency region, for example, 120K-250K Hz, and the second signal is in the second frequency region, for example, 40K-80K Hz.

In view of the above, the present invention utilizes the radio frequency module of the digital pen to send out the first signal and the second signal at two ends of the pen body of the digital pen respectively, which are then received by the radio frequency module of the digital panel, so as to make the digital pen correspond to the writing and erasing operations respectively, thus, it is more convenient for the user to write and erase data on the digital panel. Additionally, whether the first signal or the second signal will be sent out by the radio frequency module of the digital pen can be determined by the push button switch in the present invention, such that it is more convenient for the user to write and erase data on the digital panel through the digital pen.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A digital pen, comprising:
a pen body, having a first end and a second end; and
a radio frequency module, installed within the pen body, for sending out a first signal at the first end and a second signal at the second end, wherein a first frequency region of the first signal is not overlapped with a second frequency region of the second signal.

2. The digital pen as claimed in claim 1, wherein the first end is a pen nib of the pen body and the second end is a pen tail of the pen body opposite to the pen nib.

3. The digital pen as claimed in claim 1, wherein the first signal makes the digital pen correspond to a writing operation and the second signal makes the digital pen correspond to an erasing operation.

4. The digital pen as claimed in claim 1, wherein the first frequency region falls within 120K-250K Hertz (Hz) and the second frequency region falls within 40K-80K Hz.

5. A digital pen, comprising:
a pen body;
a radio frequency module, installed within the pen body for sending out a signal with the frequency being in a first frequency region; and
a push button switch, disposed on the pen body and electrically connected to the radio frequency module, for adjusting the frequency of the signal sent out by the radio frequency module from the first frequency region to a second frequency region upon being pushed, wherein the second frequency region is not overlapped with the first frequency region.

6. The digital pen as claimed in claim 5, wherein the push button switch is a one-way switch.

7. The digital pen as claimed in claim 5, wherein when the push button switch is not pushed, the signal makes the digital pen correspond to a writing operation; when the push button switch is being pushed, the signal makes the digital pen correspond to an erasing operation.

8. The digital pen as claimed in claim 5, wherein the push button switch is a two-way switch, which is switched between a first position and a second position.

9. The digital pen as claimed in claim 5, wherein when the push button switch is at a first position, the signal makes the digital pen correspond to a writing operation; when the push button switch is at a second position, the signal makes the digital pen correspond to an erasing operation.

10. The digital pen as claimed in claim 5, wherein the first frequency region falls within 120K-250K Hz and the second frequency region falls within 40K-80K Hz.
